(19) United States
(12) Patent Application Publication
(10) Pub. No.: US 2004/0253391 A1
(43) Pub. Date: Dec. 16, 2004

(54) HEAT-SENSITIVE STENCIL PLATE MATERIAL FOR STENCIL PRINTING, METHOD AND APPARATUS FOR PRODUCING THE STENCIL PLATE MATERIAL AND STENCIL PRINTING MACHINE

(76) Inventors: Yoshihide Sugiyama, Wakayama (JP); Yasunari Okagaito, Wakayama (JP)

Correspondence Address: BURNS DOANE SWECKER & MATHIS L L P, POST OFFICE BOX 1404, ALEXANDRIA, VA, 22313-1404, US

(21) Appl. No.: 10/485,458

(22) PCT Filed: Jul. 30, 2002
(86) PCT No.: PCT/JP02/07697

(30) Foreign Application Priority Data
Aug. 2, 2001 (JP) 2001-234852

(51) Int. Cl. B32B 1/00

(52) U.S. Cl. 428/32.6; 428/156

(57) ABSTRACT

The present invention provides a plate material made only of thermoplastic resin film by use of a polyester film so that an ink-penetrating opening can be thermally perforated without increasing the output of a thermal head. The film is a heat sensitive stencil plate material 12 for stencil printing having a predetermined thickness, and is composed of an extended PET film or a extended low melting temperature film produced by copolymerizing PET and PBT. Many minute recesses 14 are formed on one side of the film by templating. The templating can be carried out at a working pressure of 10⁴×10^{2(m-t)/(m-g)} Pa or more, when the working temperature is t° C.; the melting point of the film is m(° C.) and the glass transition point of the film is g(° C.).

### TECHNICAL FIELD

The present invention relates to a heat-sensitive stencil plate material (stencil sheet) for stencil printing, which consists only of a thermoplastic resin film substantially without ink-permeating supporters, such as Japanese paper and nonwoven fabric, a method and an apparatus for producing the heat-sensitive stencil plate material, and a stencil printing machine. In addition, above expression of “It consists only of a thermoplastic resin film substantially” intends to include such a construction of the film that antistatic coating and weld prevention coating may be given on a surface of the film, on condition that it have no ink-permeating supporter.

### BACKGROUND ART

Conventionally, so-called laminated type stencil sheet is utilized as a stencil sheet for stencil printing, and comprises an ink-permeating supporter and a thermoplastic resin film which is stuck on the supporter with adhesives. The ink-permeating supporter is made of Japanese paper or nonwoven fabric and the like. The thermoplastic resin film is made from polyester and the like. A thickness of the thermoplastic resin film is 1.5 μm to generally a thickness of the supporter being about 30-40 μm. Printing is performed by taking out ink from a stencil plate which is formed by thermally perforating the film. Said thermal perforation is mainly performed by heating of a thermal head, namely, said stencil sheet is inserted between the thermal head and a platen roller, and then is heated by the thermal head.

Respect to stencil printing performed by using such a stencil plate made or engraved by the above mentioned method, from before, various inconveniences or disadvantages of using the stencil plate which is stuck the thermoplastic resin film with adhesives, are mentioned. Meanwhile, various improvement proposals, which constitute a stencil plate only of a thermoplastic resin film without supporters, are proposed. However, none of the proposals has resulted in utilization now, and any proposals must overcome certain technical problems. When the stencil plate particularly is constituted only of a thermoplastic resin film, it is hard to deal with the stencil plate if a thickness of the film is not made to some extent thick. In addition, it is necessary to enlarge an output force of the thermal head in order to carry out thermally perforating at the thick film. That caused various problems and has become the greatest difficulty of utilization.

Japanese examined patent publication NO.51-499 discloses a heat-sensitive stencil sheet that is performed by templating(or impressing) to one side of a thermoplastic resin film without any supporter. This film is not perforated by a thermal head, but is perforated by heating of infrared irradiation, and vinylidene-chloride ˜vinyl chloride copolymer, polypropylene, polyvinyl chloride, etc. can be used as said thermoplastic resin film. However, they are comparatively flexible thermoplastic resin material, and although such materials can be templated (or impressed) comparatively easily, it is required about 15-60 μm (in the embodiment, said thickness is about 25 μm) as the thickness of the thick section of the film. Therefore, the stencil sheet does not become so thin compared with the so-called laminated type stencil sheet which has a supporter, and does not result in utilization now.

Moreover, even if a technical problem is occurred, whether a polyester sheet used for laminated type stencil sheet can be independently used as thermoplastic resin film or not, since the polyester resin film has quite high hardness, it is very difficult to template this, and it has not resulted in realization until now.

### DISCLOSURE OF INVENTION

(Problems to be Solved by the Invention)

The present invention is originated or created in view of the above mentioned problems of the Prior arts and to solve them effectively. Therefore, the present invention tends to constitute a stencil sheet (plate) only of a thermoplastic resin film, and tends to provide a stencil plate material made thinly enough compared with the laminated type stencil sheet, a method and an apparatus for producing them and a stencil printing machine which is equipped with the producing apparatus.

In particular, the present invention makes it possible to constitute stencil sheet (plate material) only of comparatively hard polyester film in thermoplastic resin, and attain the embodiment.

Means for Solving the Problems

A heat-sensitive stencil plate material for stencil printing according to the present invention is constituted as follows, in order to solve the technical problems of the prior arts and to attain the purposes.

The heat-sensitive stencil plate material has a predetermined thickness and is constituted of an extended polyethylene-terephthalate(PET) film or an extended low melting point film by copolymerizing polyethylene terephthalate(PET) and polybutylene terephthalate(PBT), as a thermoplastic resin film. As for this film, many minute recesses or crevices are formed in one side of the film by templating(or impressing). In the case of the extended polyethylene-terephthalate (PET) film, it is preferable to template at 50° C. or more and at 270° C. or less, namely between 50° C. and 270° C. condition, more preferably at 80° C. or more and at 180° C. or less, namely between 80° C. and 180° C. condition. Moreover, in the case of the extended low melting point film by copolymerizing the polyethylene terephthalate (PET) and polybutylene terephthalate (PBT), it is preferable to template at 50° C. or more and at 120° C. or less, namely between 50° C. and 120° C. condition.

Another heat-sensitive stencil plate material for stencil printing according to the present invention has a predetermined thickness and is constituted of a film made of a polyethylene-terephthalate (PET) film with 20% or less of crystallinity, or a low melting point film by copolymerizing polyethylene terephthalate (PET) with 20% or less of crystallinity and polybutylene terephthalate (PBT). As for this film, many minute recesses are formed in one side of the film by templating (or embosssing). In the case of the polyethylene-terephthalate (PET) film with 20% or less of crystallinity, it is preferable to template at 30° C. or more and at 270° C. or less condition, more preferably at 60° C. or more and at 100° C. or less condition. Moreover, in the case of the extended low melting point film by copolymerizing polyethylene terephthalate (PET) with 20% or less of the crystallinity and polybutylene terephthalate (PBT), it is preferable to template at 40° C. or more and at 100° C. or less condition.

Moreover, it is preferable that the above mentioned templating is performed under the pressure of 100 million Pa or more (1 or more t/cm²) when the working temperature is under the glass transition point of the film. When the working temperature is more than the glass transition point of a film, it is preferable that the above mentioned templating is performed under the pressure of 200,000 Pa or more (2 or more t/cm²). Or, when the working temperature is set t° C., the melting point of the film is set m° C. and the glass transition point is set g° C., it is preferable that the templating is performed by P Pa of working pressure force of 10⁴×10^{2(m-t)/(m-g)} or more.

It is preferable that the thickness of the above mentioned film is 1.5 μm or more and 20 μm or less. It seems that the above 1.5 μm is the minimum marginal thickness of the film for handling. If the film too thin, it will be fold easily torn. Therefore, considering the ease of dealing with it, probably, 4 μm or more or about 5 μm or more will be desirable. Moreover, probably, about 4 μm or more or about 5μ will or more is desirable as the thickness which can form the recesses or crevices of the suitable depth, without spoiling the intensity of the film itself, when forming minute recesses. Conversely, when the thickness of the film becomes exceeding 20 μm, a difference between the thickness of the film and the thickness of the conventional laminated type stencil sheet becomes small. Thus, a merit which can make the stencil sheet itself thin becomes reduce, and it becomes waste of material.

After templating of the above mentioned recesses, it is desirable to extending it further. A peculiarity, like distortion or curl of the film by templating, can be removed by extending. Thereby, it becomes easy to deal with the stencil plate material. Furthermore, since an extension stress concentrates on a thin-walled portion of the recess by extending, the thin-walled portion becomes still thinner, and it becomes possible to make plate with fewer energies.

The above mentioned minute recess may be a penetrated hole which is so small not to permit ink transparency. In this case, as for the penetrated hole, it is preferable that a diameter of an opening in one side of the above mentioned film is made larger than a diameter of an opening in another side of the film.

Moreover, the above mentioned minute recess may be a dent which reduces the thickness of the above mentioned film partially and forms the thin-walled portion. In this case, as for the thickness of the thin bottom formed by the above mentioned dent, it is preferable that it is 10% or more and 80% or less of film thickness.

As for an average array pitch of the above mentioned minute recess, it is preferable that the average array pitch of the minute recesses is finer than a pitch of a heater of a thermal head for making plate. When a heat source is a laser for making plate, it is preferable that the average array pitch of the minute recess is finer than a feed pitch of the laser.

Next, a method for producing the heat-sensitive stencil plate material for stencil printing according to the present invention is constituted as follows. Namely, an extended polyethylene-terephthalate(PET) with predetermined thickness is inserted between a templating body and a supporter. The templating body has many minute projections on its surface. The supporter has a smooth flat surface countering the surface of the templating body. Then, the surface of the film between the templating body and the supporter is pressed at 50° C. or more and 270° C. or less. Furthermore, as for the above mentioned templating processing, it is more desirable to be performed below 80° C. or more 180° C.

Another method for producing the heat-sensitive stencil plate for stencil printing according to the present invention is constituted as follows. Namely, an extended polyethylene-terephthalate(PET) film with 20% or less of crystallinity is inserted between the templating body and the supporter, and the working temperature is set at 30° C. or more and 270° C. or less. As for the working temperature, it is still more desirable to set 60° C. or more and 100° C. or less.

Alternative method for producing the heat-sensitive stencil plate material for stencil printing according to the present invention is constituted as follows. Namely, an extended low melting point film by copolymerizing polyethylene terephthalate(PET) with 20% or less of crystallinity and polybutylene terephthalate (PBT) is inserted between the templating body and the supporter, and the working temperature is set at 50° C. or more and 120° C. or less.

More Alternative method for producing the heat-sensitive stencil plate for stencil printing according to the present invention is constituted as follows. An extended low melting point film by copolymerizing polyethylene terephthalate(PET) with 20% or less crystallinity and polybutylene terephthalate (PBT) is inserted between the templating body and the supporter, and the working temperature is set at 40° C. or more and 100° C. or less.

As for above mentioned methods of the stencil plate material for stencil printing, it is preferable that each templating process is performed under the pressure of 100 million Pa or more (two or more 1 t/cm) when the working temperature is under the glass transition point of the film. When the working temperature is more than the glass transition point of the film, it is preferable to be performed under the pressure of 200,000 Pa or more (2 or more kg/cm²). When the working temperature is set t° C., the melting point of the film is set m° C. and the glass transition point of the film is set g° C., it is preferable that templating is performed by P Pa of the working pressure force of 10⁴×10^{2(m-t)/(m-g)} or more.

The above mentioned templating body and the above-mentioned supporter in these producing methods may be a 1st and 2nd cylindrical bodies of revolution like a roller, respectively. Or, the above-mentioned templating body may be an endless belt-like body of revolution. The above mentioned supporter may be a cylindrical body of revolution of which a surface facings the surface of the templating body, and makes a press force act on the surface of the stencil plate material.

Furthermore, an apparatus for extending can also be placed at next place of the templating body and the supporter for forming the recess. Thereby, a peculiarity like distortion or curl of the film by templating can be removed, and it becomes easy to handle the stencil plate material. Furthermore, since an extension stress concentrates on the thin-walled portion of the recess by extending, the thin-walled portion becomes still thinner, and it becomes possible to plate-making with fewer energies.

Naturally, the minute recess formed by this method may be a penetrated hole which is so small not to permit ink permeating. In this case, as for the penetrated hole, it is preferable that a diameter of an opening in one side of the film is made larger than a diameter of an opening in another side of the film. Moreover, the minute recess may be a dent which reduces the thickness of the film partially and forms a thin-walled portion.

Moreover, an apparatus for producing the heat-sensitive stencil plate material according the present invention is constituted as follows.

The apparatus is constituted of a film conveyance path, an templating body and a supporter, in which the film conveyance path conveys the heat-sensitive stencil plate material for stencil printing which is made of a polyester film of predetermined thickness, the templating body has many minute projections on the surface facing the conveyance path, and the supporter has a smooth flat surface facing the film conveyance path and countering to the face of the templating body. Then, the film conveyance path is placed between the templating body and the supporter body. When the working temperature is set t° C., the melting point of the film is set m° C. and the glass transition point of the film is set g° C., Both the templating body and the supporter make P-Pa pressure force of 10⁴×10^{2(m-t)/(m-g)} more than act on the surface of the stencil plate material which runs between them, so that minute recesses are continuously formed in the one side of the stencil plate material.

The polyester film conveyed in the film conveyance path in the apparatus for producing the stencil plate material may be constituted as follows. Namely, the polyester film is constituted of an extended polyethylene-terephthalate (PET) film, a polyethylene-terephthalate (PET) film with 20% or less of crystallinity, an extended low melting point film by copolymerizing polyethylene terephthalate (PET) and polybutylene terephthalate (PBT), or a low melting point film by copolymerizing polyethylene terephthalate (PET) with 20% or less of crystallinity and polybutylene terephthalate (PBT).

The templating body and the supporter in this apparatus may be a 1st and 2nd cylindrical bodies of revolution like a roller, respectively. Or, the templating body may be an endless belt-like body of revolution.

An apparatus for extending can also be placed at a next place to the templating body and the supporter for forming the recess. Thereby, a peculiarity like distortion or curl of the film by templating can be removed, and it becomes easy to handle the stencil plate. Furthermore, since an extension stress concentrates on the thin-walled portion of the recess by extending, the thin-walled portion becomes still thinner, and it becomes possible to make plate with less energy.

Naturally, the minute recess formed in this apparatus may be a penetrated hole which is so small not to permit ink permeating. In this case, as for the penetrated hole, it is preferable that a diameter of an opening in one side of the film is made larger than a diameter of an opening in another side of the film. Moreover, the recess may be a dent which reduces the thickness of the film partially to form a thin-walled portion.

Moreover, respect to a machine for stencil printing according to the present invention, -the stencil sheet conveyance path for conveying the stencil sheet to the plate-making section may be utilized as a film conveyance path. In the case, the apparatus for producing the heat-sensitive stencil plate material according to the present invention can be disposed on the film conveyance path. (more utilized effects than the prior art) It realizes to consist only of a thermoplastic resin film and carry out stencil printing.

### BRIEF DESCRIPTION OF THE DRAWINGS

FIG. 1 is a drawing showing a concept of a method and an apparatus for plate-making in using a heat-sensitive stencil plate material for stencil printing according to the present invention.

FIG. 2 is a drawing showing a concept about a structure of a heat-sensitive stencil plate material for stencil printing according to the present invention.

FIG. 3 is a drawing showing a concept about a structure of a heat-sensitive stencil plate material for stencil printing according to the present invention.

FIG. 4 is a graphical representation showing a data of an experiment which was carried out to search for proper processing conditions at the time of templating minute recesses on an extended PET film.

FIG. 5 is a graphical representation showing a data of an experiment which was carried out to search for proper processing conditions at the time of templating minute recesses on a PET film with 20% or less of crystallinity.

FIG. 6 is a graphical representation showing a data of an experiment which was carried out to search for proper processing conditions at the time of templating minute recesses on an extended low melting point film by copolymerizing of PET and PBT.

FIG. 7 is a graphical representation showing a data of an experiment which was carried out to search for proper processing conditions at the time of templating minute recesses on an extended low melting point film by copolymerizing of PET with 20% or less of crystallinity and PBT.

FIG. 8 is a graphical representation showing a relation between a working pressure force and a working temperature, as conditions to template a stencil plate material for stencil printing according to the present invention.

FIG. 9 is a drawing showing a concept of a method and an apparatus for producing a heat-sensitive stencil plate material for stencil printing according the present invention.

FIG. 10 is a drawing showing a concept of a method and an apparatus for producing a heat-sensitive stencil plate material for stencil printing according the present invention.

FIG. 11 is a drawing showing a process in which minute projections are stuffed into a film as to form minute recesses, and a state before a pressurization by the minute projections is shown.

FIG. 12 is drawing showing a process in which minute projections are stuffed into a film as to form minute recesses, and a state on the way of pressurization by minute projections is shown.

FIG. 13 is drawing showing a process in which minute projections are stuffed into a film as to form minute recesses, and a state at the time of the pressurization end by minute projections is shown.

### BEST MODE FOR CARRYING OUT THE INVENTION

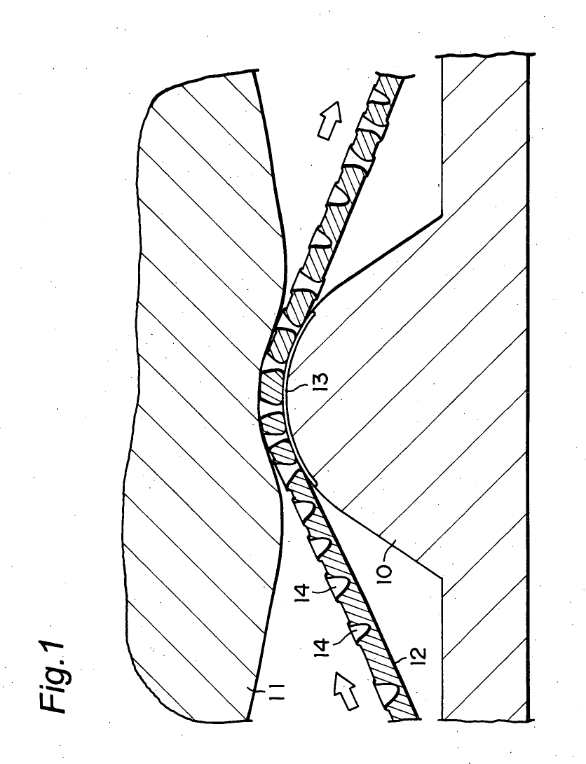

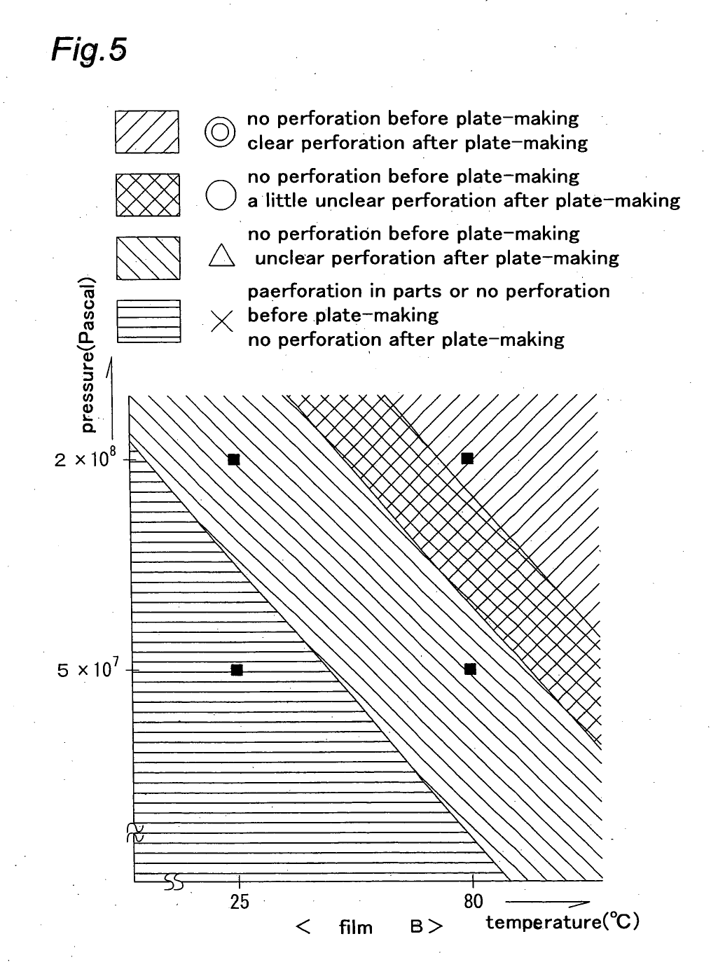

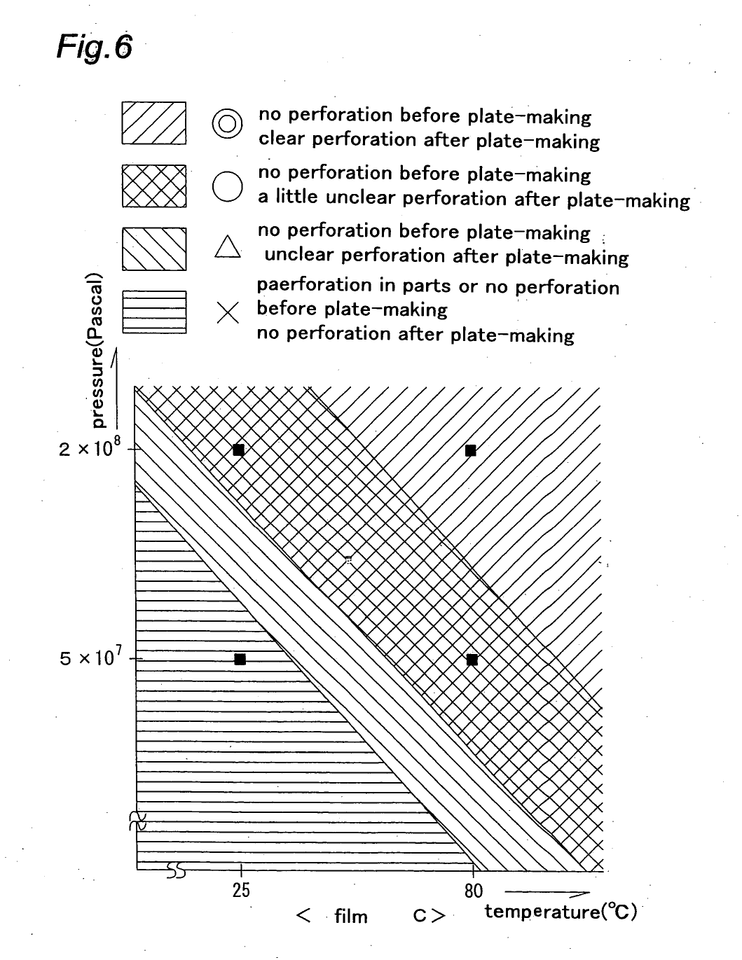

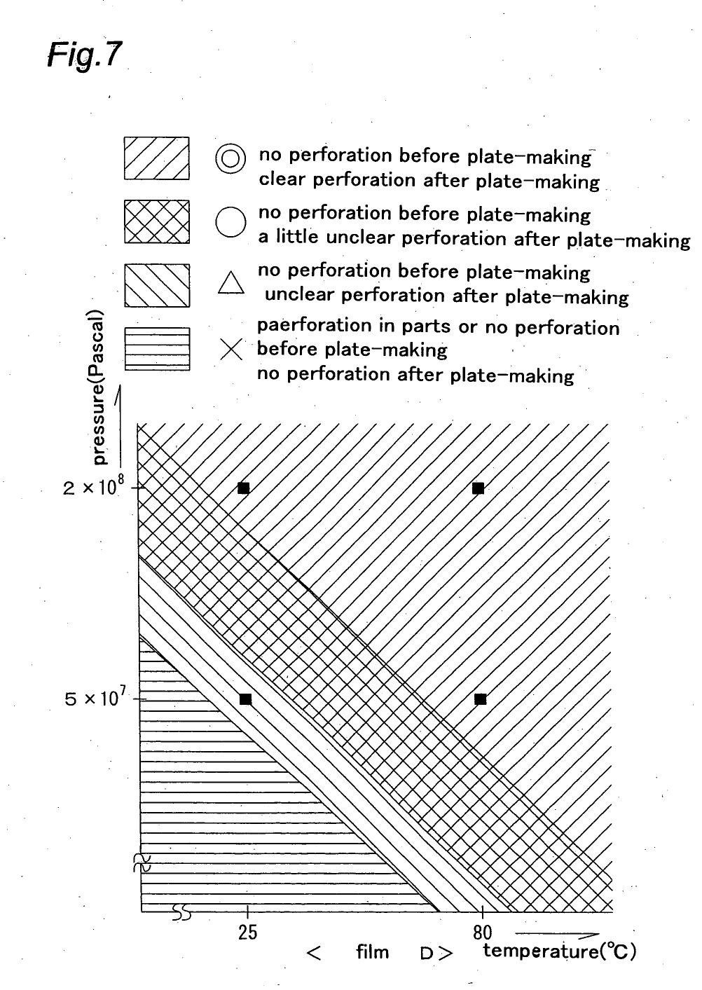

Referring to FIG. 1 to FIG. 13, embodiments of a heat-sensitive stencil plate material for stencil printing, its method and its apparatus according to the present invention will be described hereunder. FIG. 1 is an outline drawing illustrating the method for plate-making in using the heat-sensitive stencil plate material for stencil printing according to the present invention. In FIG. 1, the numeral 10 designates a thermal head, and the numeral 11 designates a platen roller. A stencil sheet 12 consisting of an extended polyethylene-terephthalate (PET) film is sent to the right-side from the left-side in the direction of an arrow of FIG. 1. Although FIG. 1 is an enlarged sectional view, an actual size of each composition, for example a thickness of the stencil sheet 12 is about several μm, and a length of a heater section 13 of the thermal head 10 is about 10 μm to 100 and several 10 μm in a stencil sheet feed direction. Moreover, although the platen roller 11 is partially shown in FIG. 1, it is a rubber roller which has a diameter about 20 mm.

In addition, other thermoplastic resin film usable as the stencil sheet, is a polyethylene-terephthalate (PET) film with 20% or less of crystallinity, an extended low melting point film by copolymerizing polyethylene terephthalate (PET) and polybutylene terephthalate (PBT), or a low melting point film by copolymerizing polyethylene terephthalate (PET) with 20% or less of crystallinity and polybutylene(PBT).

Many minute or micro recesses 14 are formed on one side of the stencil sheet 12 by random arrangement. Said side is in contact with the platen roller 11. FIG. 1 shows a state where the thermal head 10 is electrified so that a portion of the stencil sheet 12, which is in contact with the heater section 13, is perforated. The stencil sheet 12 is penetrated by fusing a bottom of the minute recess 14, and an ink permeable opening is formed. Thus, the ink permeable opening can be formed in a desired part to make plate by controlling an electrification to the heater section 13 of the thermal head 10, whether ON or OFF.

Thus, since the minute recesses 14 are formed on the one side of the film stencil sheet 12, when the film stencil sheet 12 is heated and perforated from an opposite side of it, it will become possible to form ink permeable openings by fusing and penetrating only the bottom portion of the recess 14, without penetrating all the thickness of the film.

A density in which the minute recess 14 is formed can be changed according to desired resolution. As for the density of the recesses 14, it is suitable that a rate of opening becomes about 5-30% per 1 dot, to bring beautiful printing, and prevent a back projection and a strike-through. That is, the area of the film which is in contact with one heater section 13 of the thermal head 10 is equivalent to 1 dot of a matrix and it must to arrange at least one minute recess 14 in the area. If the number of the minute recess 14 is increased, the number of the ink permeable opening per 1 dot, when the heater section 13 is energized or electrified, increases corresponding to the increase of the number of the minute recess 14, and the rate of opening becomes high.

Moreover, although an array of the minute recess 14 may be regular, it is preferable that the array is irregular within fixed limits responding to a desired rate of opening so as to prevent a phenomenon of “moire”. The phenomenon of “moire” means that a shade of ink appears in the shape of stripes on a print sheet. In the case of any, the average pitch of the minute recess 14 is set finer than the array pitch of the heater section 13 of the thermal head 10.

After forming the recess by templating, it is also possible further to extend the stencil sheet 12. Thereby, a peculiarity like distortion or curl of the film occurred by templating can be removed, and the plate material becomes a good handling plate material easy. Furthermore, since an extension stress concentrates on the thin-walled portion of the recess by extending, the thin-walled portion becomes still thinner, and it becomes possible to make plate with less energy.

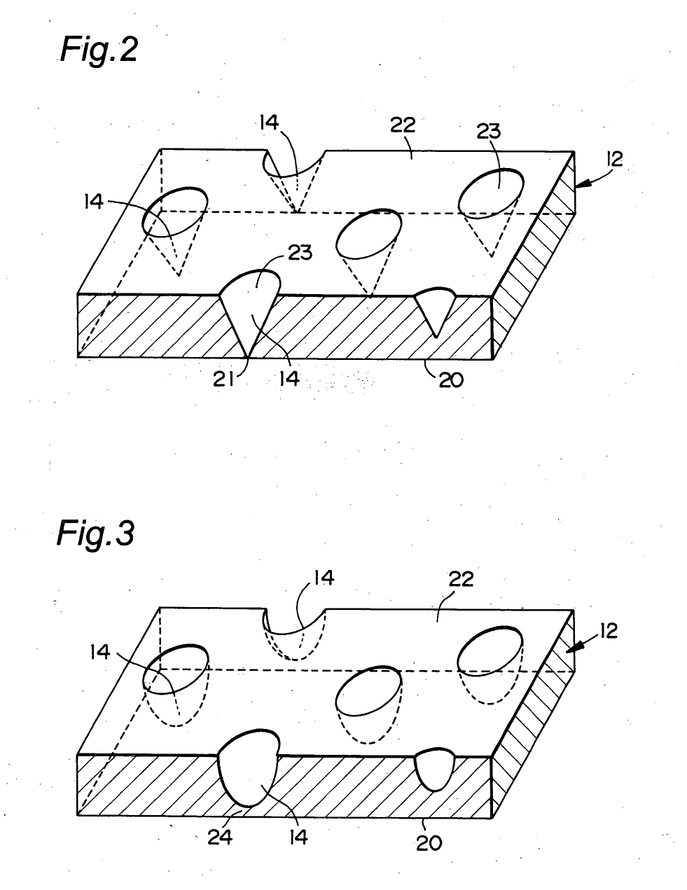

FIG. 2 is a sectional perspective view showing the stencil sheet 12 in which the minute recess is a penetrated hole, but said hole is so small not to permit ink permeability. Although an opening 21 on a surface 20 which is heated at the time of plate-making is so small not to permit ink permeability, an opening 23 on a surface 22 of an opposite side may be larger than it, and may be large so that the ink enter into the minute recess 14. In addition, FIG. 3 shows a situation that the minute recess 14 is formed in the shape of a dent with a thin bottom 24.

Moreover, when the minute recess 14 is formed in the shape of the dent, it is preferable that the thickness of the thin bottom 24 is about 80% or less of the thickness of the film, but said the thickness rate depends on material of the film. In addition, a residual stress may be occurred at the time of the extension of the film, and said stress may concentrates on the minute recess of the surface to urge opening, in that case, it is effective also in the recess of about 20% of the depth of the film thickness. On the other hand, when little residual stress is occurred at the time of the extension of the film, it is necessary to make the depth of the recess deep (for the thickness of the thin bottom to be thin), in that case, it is preferable that the thickness of the thin bottom is about 2 μm or less.

In addition, although the thermal head is generally used for a heat source for thermally perforating the stencil sheet 12, as other means, a laser may be also used for a heat source. In this case, it can make the output of the laser small, as same as the thermal head. When the laser is used for a heat source, an average pitch of the minute-recess 14 is arranged is made finer than a feed pitch of the laser.

In order to form the minute recess 14 on the stencil sheet 12 which consists of a thermoplastic resin film, a templating of the film is performed out by forcing projections on one side of the film. It is generally difficult to force the projection on a thin film-like sheet so as to form a penetrated hole. In that case, usually, a layer of pellicle state remains on an opposite side of a projection forcing side (namely, it becoming a dent which forms a thin bottom), or it is forced only against the grade in which an opening about a crack (small opening of the grade which does not permit ink permeability) is formed slightly. If it is processed using this property, the suitable minute recess will be formed on a processing side. Consequently, even if the minute recess reaches the face of the opposite side, the opening will not become the extent that ink permeability is permitted.

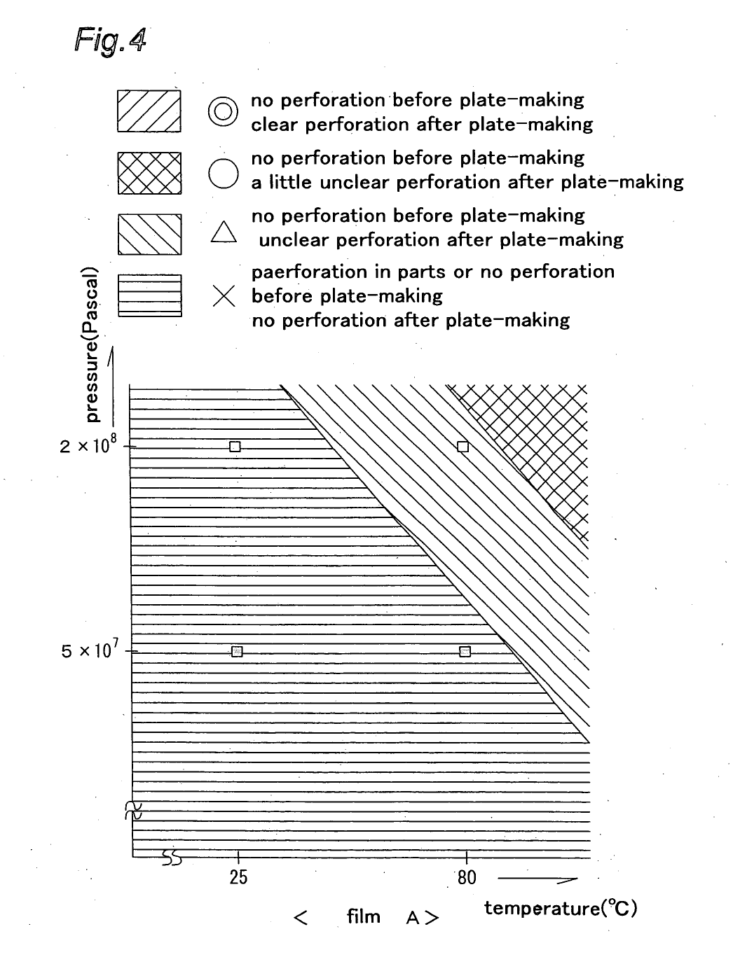

Following experiments were carried out in order to search for the proper processing conditions at the time of templating of the minute recess on the film, which had each quality of the material mentioned above. Each used film has 12 μm thickness respectively, and consists of as follows. The film A consists of an extended PET film. The film B consists of a PET film with 20% or less of crystallinity. The film C consists of a low melting point film by copolymerizing PET and PBT. The film D consists of a low melting point film by copolymerizing PET with 20% or less of crystallinity and PBT. Photo etching with a depth of 18 μm is performed to a surface of a stainless steel board with a thickness of 0.2 mm, thereby, such a templating material can be obtained that has many circular minute projections having a diameter of 40 μm and a height of 18 μm, and arranged in 60 μm pitch each other's. Each above-mentioned film was put on said templating material, respectively, and was passed through between a pair of iron rollers with a diameter of 100 mm and a length of 200 mm length. Each templating of said film was performed on the processing conditions of various kinds of working temperatures and various kinds of working pressure forces, to produce various stencil plate materials. Then, plate-making performed about each plate on the following plate-making conditions. As plate-making conditions, we used a 400 DPI thermal head of the partial glaze of which a main-scanning-direction heater size is 47 μm and a sub-scanning-direction heater size is 80 μm. And an output energy of the thermal head is set 20 mm joule per 1 mm². The graphs of FIG. 4-FIG. 7 show the experimental results. Moreover, evaluations about the quality of plate-making are shown in Table 1 as an example of representation of the experimental data about the case where working pressure force is set 200 million Pa and 50 million Pa, and about the case where working temperatures are set 25° C. and 80° C.

TABLE 1

| | temperature | 200 million Pa | 50 million Pa |
|---|---|---|---|
| film A | 25° C. | x: perforation in parts | x: no perforation before |
| (for | | before plate-making, | plate-making, |
| general) | | no perforation after | no perforation after |
| | | plate-making | plate-making |
| | 80° C. | Δ: no perforation | x: no perforation before |
| | | before plate-making, | plate-making, |
| | | unclear perforation | no perforation after |
| | | after plate-making | plate-making |
| film B | 25° C. | Δ: no perforation | x: no perforation before |
| (low | | before plate-making, | plate-making, |
| crystal- | | unclear perforation | no perforation after |
| linity) | | after plate-making | plate-making |
| | 80° C. | ⊚: no perforation | Δ: no perforation before |
| | | before plate-making, | plate-making, |
| | | clear perforation after | unclear perforation after |
| | | plate-making | plate-making |
| film C | 25° C. | ∘: no perforation | x: no perforation before |
| (low | | before plate-making, | plate-making, |
| melting | | a little unclear | no perforation after |
| point) | | perforation after plate- | plate-making |
| | | making | |
| | 80° C. | ⊚: no perforation | ∘: no perforation before |
| | | before plate-making, | plate-making, |
| | | clear perforation after | a little unclear |
| | | plate-making | perforation after plate- |
| | | | making |
| film D | 25° C. | ⊚: no perforation | Δ: no perforation before |
| (low | | before plate-making, | plate-making, |
| melting | | clear perforation after | unclear perforation after |
| point, | | plate-making | plate-making |
| low | 80° C. | ⊚: no perforation | ⊚: no perforation before |
| crystal- | | before plate-making, | plate-making, |
| linity) | | clear perforation after | clear perforation after |
| | | plate-making | plate-making |

In the above evaluation, X mark, Δ mark, ◯mark and ⊚ mark are given based on each state of before plate-making and after plate-making.

The X mark means that using of the plate was impossible. Namely, before plate-making, some perforations to the extent that ink permeating was produced were occurred in parts or no perforation was occurred, after plate-making, no perforation by heating of the thermal head was occurred and ink permeating was impossible.

The Δ mark means an unclear perforation. Namely, before plate-making, no perforation to the extent that ink permeating was produced was occurred, after plate-making, a perforation by heating of the thermal head was not enough to make ink permeate.

The ◯ mark means a little unclear perforation. Namely, before plate-making, no perforation to the extent that ink permeating was produced was occurred, after plate-making, a perforation by heating of the thermal head was enough to make ink permeate, but the perforation was a little unclear.

The ⊚ mark means clear perforation. Namely, before plate-making, no perforation to the extent that ink permeating was produced was occurred, after plate-making, a perforation by heating of the thermal head was enough to make ink permeate and the perforation was clear.

We consider that a boundary of the ◯ marked field and Δ marked field in each graph of these FIG. 4-7 is for a boundary of a usable plate as a stencil plate material and an unusable plate. Although the boundaries differ with each film, they have an inclination common as relation between the working pressure force and the working temperature. That is, as the working temperature becomes high, the working force can be made low. From the relation of the actual working temperature to the glass transition point and the melting point of each film, this common inclination can be regarded as a relation of the working temperature and working pressure force, and it can ask for the formula which generalizes the relation.

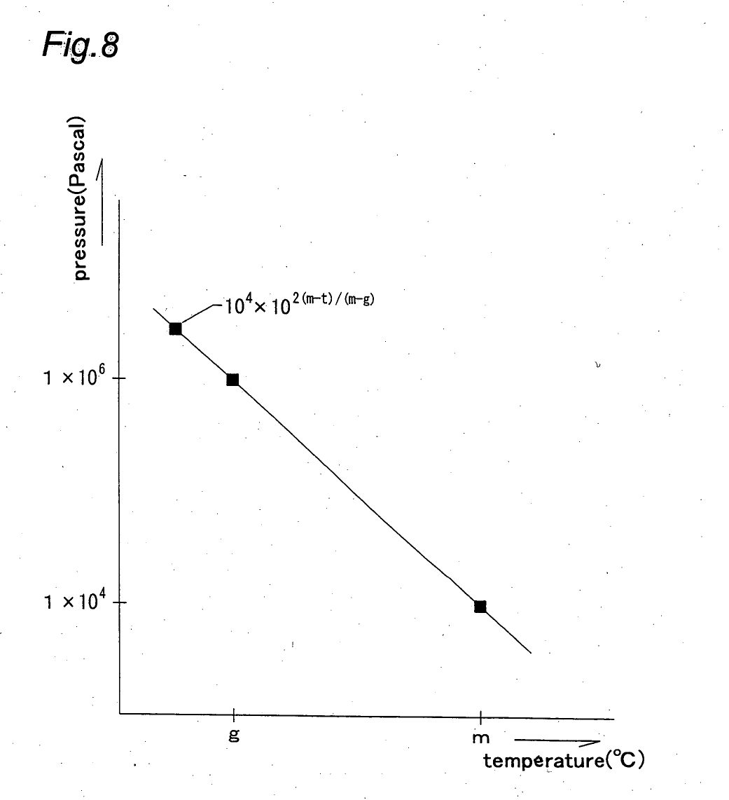

That is, when the working temperature is set t° C., the melting point of the film is set m° C. and the glass transition point of the film is set g° C., the templating processing corresponding the ◯ marked field or the ⊚ marked field can be performed by P Pa of working pressure force of 10⁴×10^{2(m-t)/(m-g)} or more. The graph of FIG. 8 shows that relation. And when the working pressure force is 10⁴×10^{2(m-t)/(m-g)} or below, sufficient perforating is no longer obtained. That is, since the thin bottom of the minute recess does not become thin enough, perforating by normal heating of the thermal head for the bottom is not sufficient, thereby perforating after plate-making becomes unclear.

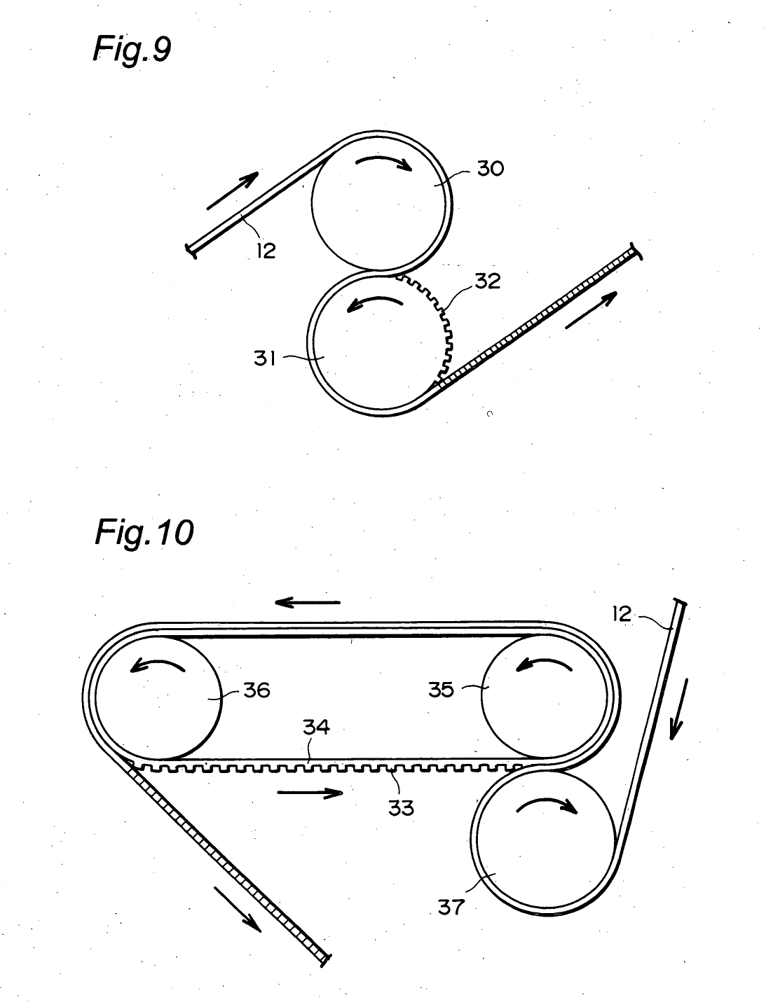

FIG. 9 shows a concept of a method and an apparatus for producing the heat-sensitive stencil plate material according to the present invention. A pair of rollers 30 and 31 is arranged so that they counter mutually. One roller 31 is used as a templating roller, and minute projections are formed on a peripheral face perimeter of the roller 31. Another roller 30 is a supporting roller with a smooth peripheral face. The templating is performed by inserting the thermoplastic resin film 12 with a fixed thickness between the templating roller 31 and the supporting roller 30 which rotate in the direction of an arrow. Working conditions shall fulfill above-mentioned conditions.

FIG. 10 shows a concept of alternative method and apparatus for producing the stencil plate material. A metal belt 34 is built over between rollers 35 and 36 which rotate and drive. The metal belt 34 has minute projections 33 on the peripheral face perimeter of it. Moreover, a supporting roller 37, which has a smooth peripheral facing the roller 35, is arranged. The templating processing is performed by inserting the thermoplastic resin film 12 with a fixed thickness between the metal belt 34 and the supporting roller 37. Working conditions shall fulfill above-mentioned conditions.

One example for forming the minute projections 32 on the roller 31 of FIG. 9 is shown below. After carrying out plasma jet flame coating of the ceramic to the material face (peripheral face) of the metal roller, the face of the metal roller can be ground, and many minute projections 32 can be further formed by laser engraving. A pitch of the minute projection 32 is preferable to 100 μm or less, more preferable to 30 μm or less. A depth of laser engraving is set to 3-40 μm, the minute projections 32 of 70% -200% of height of film thickness are formed on the roller 31, thus the roller 31 is made as a templating roller.

The 1st advantage using a roller as a templating body is that surface hardening is easy compared with the case where it considers as a belt. In other words, the belt coated by ceramic is difficult to use due to a lack of flexibility, however, in the case of the roller, flexibility is not required. The 2nd advantage using a roller as a templating body is that highly precise endless processing is easy. It is difficult to carry out endless processing welding of the belt so that the surface micro-processing pattern continues.

One example for forming the minute projections 33 on the metal belt 34 of FIG. 10 will be described as follows. Many minute projections 33 can be formed in the metal plate with a thickness of 0.1 mm-0.5 mm by photo etching. Also in this case, a pitch of the minute projection 33 is preferable to 100 μm or less, more preferable 30 μm or less. A depth of said photo etching is set to 3-40 μm, the minute projections 33 of 70% -200% of height of film thickness are formed on the belt 34, thus the belt 34 is made as a templating belt.

An advantage using the belt as a templating body is that it can be easily made a long size body compared with the case where it considers as a roller. If it becomes a long size body, the following two points are advantages. For the 1st point, since the stencil sheet processing area increase per 1 round of the belt, the film processing of the amount of the purposes can be performed by a few of repeats, wear of the minute projections of the part decreases and the life of the belt becomes long. For the 2nd point, since the film after processing can be in contact with the belt in a long time, heat setting can fully be performed in the meantime. On the other hand, a carrying out endless processing welding of the belt needs advanced welding technology. However, since it is not necessary to form minute projections in the joint portion of the stencil plate and the stencil plate when producing the stencil sheet with which the length per edition was decided, if it is made for the welding part to serve as the joint portion, it will become unnecessary to consider as endless processing welding, and the problem will be solved

In accordance with the conveyance path of the stencil sheet 12, the composition of FIG. 9 or FIG. 10 is arranged as an apparatus for producing the stencil plate material and then the composition of FIG. 1 is arranged, thereby, a series of plate-making apparatus are composed. Moreover, the stencil printing machine according to the present invention can also consist of building this plate-making apparatus into the stencil printing machine as a plate-making section.

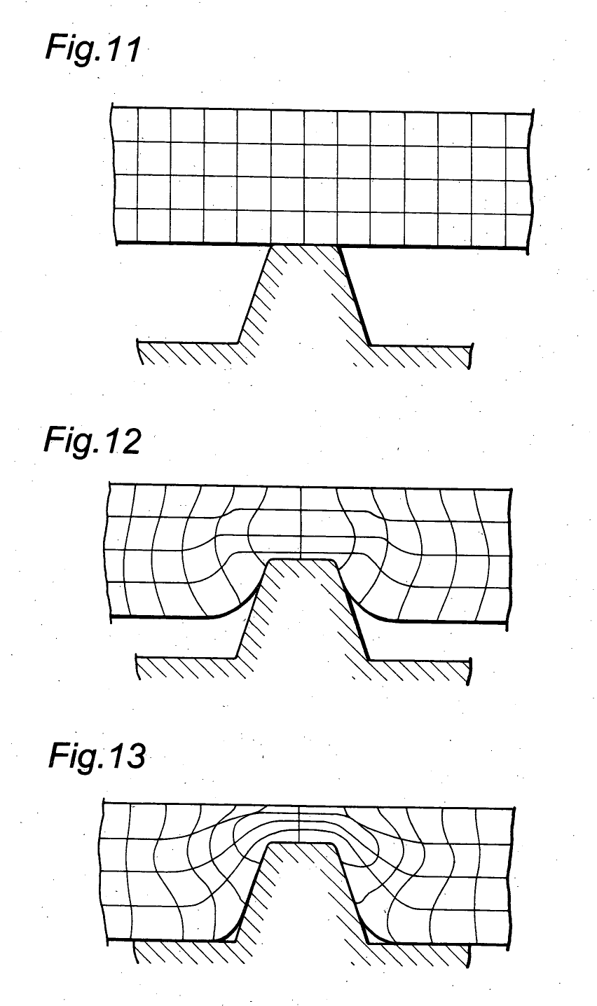

FIG. 11-13 shows a process in which minute projections are stuffed into the film to form recesses. In each drawing, gridline which shows a state of changing distortion is illustrated in the portion of the film for convenience. FIG. 11 shows a state before pressing by minute projections. FIG. 12 shows a state on the way of pressing by minute projections. FIG. 13 shows a state at the time of pressing by minute projections. As shown in these drawings, the portion used as the bottom of the recess is horizontally or laterally extended in a process which the recess is formed. That is, the bottom of the recess is extended at the rate higher than other portions. Since the bottoms of the recesses, which begin to dissolve by heating at the time of plate-making, are pull each other by a large stress corresponding to the rate of the extension, a dissolution portion is cracked so as to spread to a circumference, and it will realize prompt perforating.

In addition, a shape of the minute projection may be a cylindrical shape, a prism shape, a truncated-cone shape or a truncated-pyramid shape. Moreover, in the truncated-cone shape or the truncated-pyramid shape, an area of its top portion may be comparatively larger than an area of its bottom portion; on the other hand, the area of its top portion may be comparatively smaller than the area of its bottom portion.

As for heat-sensitive stencil plate material according to the present invention, since the stencil sheet consists of only thermoplastic resin film, a lamination with a supporter becomes unnecessary. Therefore, an inconvenience due to have the supporter is removed. For example, the lamination process becomes unnecessary. Adhesives become unnecessary. A bad influence to print qualities, such as “deformation of ink-permeating opening” etc. which adhesives bring to plate-making, is lost. A bad influence in which a fiber of a supporter enters in an opening of a perforated film, and produces, like “graze of printing” is lost. Although it will become the cause which produces curls if different-kind of materials are stuck, such a property that is easy to curl is removed. In the case of the lamination structure, ink which had been absorbed by the supporter was useless, but in the case of a structure only with a film, such futility of the ink is lost because the film is not equipped with any supporter having a thickness about 20 to 30 times the thickness of the film.

Moreover, in the case of the conventional supporter lamination composition, although the thickness of the film itself was about 1.5 μm, but in the case of the structure only with the film according to the present invention, it is possible to actually handle the film since the film has a certain amount of thickness, for example 4 to 5 μm (thickness grade of the cassette tape for sound) or more responding to a hardness of a material quality more. If another word is carried out, when the thickness of the stencil sheet is the thickness of only the film(about 1.5 μm) in the case of lamination structure, the stencil plate itself will be too thin and it will be hard to deal with it. In the present invention, since the thickness of the film itself is not as thin as the thickness in the conventional supporter lamination composition, it can effectively prevent back projection and carrying out a strike-through caused by transferring of superfluous ink to a print sheet.

In the case of the conventional lamination stencil sheet, since the thermoplastic resin film with a thickness of about 1.5 μm is perforated by heating of the thermal head, thermoplastic resin film with a thickness of 4-5 μm or more can not be perforated by heating of the same thermal head due to insufficiency of the out put of the thermal head. Moreover, if the output of the thermal head is enlarged, high heat energy gets across to a platen roller; thereby a bad influence attains the platen roller, and is not preferable for a life of the thermal head itself. However, by the method for plate-making according to the present invention, although it is based also on a kind of film material, a certain amount of thickness is given at least so as to easily handle it and the heat energy which is required in perforating does not become large compared with the conventional case. The reason is that many minute recesses are occurred on one side of the film. Thereby, an ink permeating opening can be obtained from the opposite side only by fusing the film to the grade which communicates with the minute recess in the part to perforate. In this point, it becomes possible to miniaturize the thermal head heater since it becomes possible to make the output of the thermal head smaller than before rather, thereby it is convenient for making a resolution of printing still higher than before.

Conventionally, in the case of a stencil sheet only with a thermoplastic resin film, it is difficult to deal with the stencil sheet if the thickness of the film is not made to some extent thick, it is necessary to enlarge the output of the thermal head for thermally perforating. This is the greatest problem of utilization. According to the present invention, it becomes possible to thermally perforate the ink permeating opening to the film without increasing of the output of the thermal head, and it can solve this problem.

It is preferable that the heat energy transmitted to the platen roller, which counters the thermal head on both sides of the thin thermoplastic resin film, is small as much as possible. As for this, it becomes possible to make the energy transmitted from the thermal head to the platen small enough since the output of the thermal head becomes small and the minute recess forms a heat insulation air space.

In particular, since the thermoplastic resin film is extended and an internal tensile stress at the time of the extension remains in the film, a crack occurs only by a thermal fusion of a few portions, and an opening which arrives at the minute recess of the neighborhood of it is formed. Therefore, it is not necessary to heat until a melting part arrives at the minute recess, and the output of the thermal head can be still miniaturized. Thus, in order to carry out the internal remains of the tensile stress at the time of the extension, it is necessary that a mechanical processing, such as a mold pressing processing which forms the minute recess, must be performed below at the melting point temperature of thermoplastic resin. In addition, it is preferable that the working temperature is higher than the glass-transition-point temperature of thermoplastic resin, in order to form the recess by the fewer working pressure force, preventing the crack of the film.

Moreover, by extending further the film sheet after forming the recesses on it, the stress concentrates on the thin bottom portion of the recess and said thin portion becomes still thinner. Thereby, the heat energy needed at the time of plate-making can also be made still smaller. Moreover, it is also possible to lessen the core set of the film sheet and the curl by removing the distortion at the time of the minute recess forming. Thus, it is also possible to raise the handling nature of the film sheet.

The minute projection for templating or pressing may be constituted of many particles adhered to the roller peripheral surface or the belt peripheral surface. As alternative means for templating, a particle is sprayed like shot peening. In the case of said spraying, it is preferable to utilize particles of ice or dry ice in order to prevent that particles remain on the film plane. Moreover, light energies, such as a YAG laser, and a CO2 laser, an excimer laser, can also perform recess processing. In this case, it is desirable that any portions other than the recess is not be influenced by the laser, and the processing is carried out at the ambient temperature which is below the glass transition point.

(Industrially Applicability)

The heat sensitive stencil plate material, the method and the apparatus for producing are utilized in a field of a stencil printing art.

1. A heat-sensitive stencil plate material with a predetermined thickness for stencil printing consisting of:
an extended polyethylene-terephthalate(PET) film or an extended low melting point film by copolymerizing of polyethylene terephthalate(PET) and polybutylene terephthalate(PBT),
many minute recesses are formed in one side of said the film by means of templating.

2. A heat-sensitive stencil plate material for stencil printing according to claim 1,
wherein said heat-sensitive stencil plate material for stencil printing is an extended polyethylene-terephthalate (PET) film,
said templating is performed at 50° C. or more and 270° C. or below.

3. A heat-sensitive stencil plate material for stencil printing according to claim 2,
wherein said templating is performed at 80° C. or more and 180° C. or below.

4. A heat-sensitive stencil plate material for stencil printing according to claim 1,
wherein said heat-sensitive stencil plate material for stencil printing is an extended low melting point film by copolymerizing polyethylene terephthalate(PET) and polybutylene terephthalate(PBT),
said templating is performed at 50° C. or more and 120° C. or below.

5. A heat-sensitive stencil plate material for stencil printing according to claim 1,
wherein said heat-sensitive stencil plate material for stencil printing is an extended polyethylene-terephthalate (PET) film with 20% or less of crystallinity,
said templating is performed at 30° C. or more and 270° C. or below.

6. A heat-sensitive stencil plate material for stencil printing according to claim 5,
wherein said templating is performed at 60° C. or more and 100° C. or below.

7. A heat-sensitive stencil plate material for stencil printing according to claim 1,
wherein said heat-sensitive stencil plate material for stencil printing is a low melting point film by copolymerizing polyethylene terephthalate(PET) with 20% or less of crystallinity and polybutylene terephthalate(PBT),
said templating is performed at 40° C. or more and 100° C. or below.

8. A heat-sensitive stencil plate material for stencil printing according to anyone of claims 1-7,
wherein said templating is performed under a pressure of 100 million Pa or more (1 or more t/cm²) when a working temperature of said film is below the glass transition point of this film.

9. A heat-sensitive stencil plate material for stencil printing according to anyone of claims 1-7,
wherein said templating is performed under a pressure of 200 thousand Pa or more (2 or more kg/cm²) when a working temperature of said film is or more the glass transition point of this film.

10. A heat-sensitive stencil plate material for stencil printing according to anyone of claims 1-7,
wherein said templating is performed under P Pa of a working pressure force of 10⁴×10^{2(m-t)/(m-g)} or more when a working temperature is t° C., a melting point of the film is m° C. and a glass transition point of the film is g° C.

11. A heat-sensitive stencil plate material for stencil printing according to claim 1,
wherein a thickness of said film is 1.5 μm or more and 20 μm or less.

12. A heat-sensitive stencil plate material for stencil printing according to claim 1,
wherein said material is obtained by performing extension processing further after templating of said recess.

13. A heat-sensitive stencil plate material for stencil printing according to claim 1,
wherein said minute recess is a penetrated hole which is so small not to permit ink permeability,
an opening diameter of one side of the film is larger than an opening diameter of other side of the film.

14. A heat-sensitive stencil plate material for stencil printing according to claim 1,
wherein said minute recess is a dent which reduces the thickness of said film partially and forms a thin bottom.

15. A heat-sensitive stencil plate material for stencil printing according to claim 1,
wherein an average array pitch of said recess is finer than an array pitch of a heater of a thermal head for plate-making.

16. A heat-sensitive stencil plate material for stencil printing according to claim 1,
wherein an average array pitch of said recess is finer than an array pitch of a feed pitch of a laser for plate-making.

17. A heat-sensitive stencil plate material for stencil printing according to claim 14,
wherein a thickness of said thin bottom formed by said dent is 10% or more and 80% or less of the film thickness.

18. A method for producing a heat sensitive stencil plate material comprising,
inserting a extended polyethylene-terephthalate (PET) film with a predetermined thickness between a templating body having many minute projections on its face and a supporter countering said face of the templating body and having a smooth front face,
forming many minute recess on one side of said film by bossing a face of the polyethylene-terephthalate (PET) film between the templating body and the supporter under 50° C. or more and 270° C. or less.

19. A method for producing the heat sensitive stencil plate material according to claim 18,
wherein said templating is carried out under 80° C. or more and 180° C. or less.

20. A method for producing a heat sensitive stencil plate material comprising,
inserting a polyethylene-terephthalate (PET) film with 20% or less of crystallinity between a templating- body having many minute projections on its face and a supporter countering said face of the templating body and having a smooth face,
forming many minute recess on one side of said film by templating a face of the film between the templating body and the supporter under 30° C. or more and 270° C. or less.

21. A method for producing the heat sensitive stencil plate material according to claim 20,
wherein said templating is carried out under 60° C. or more and 100° C. or less.

22. A method for producing the heat sensitive stencil plate material comprising,
inserting an extended low melting point film by copolymerizing polyethylene terephthalate(PET) and polybutylene terephthalate(PBT), between a templating body having many minute projections on its face and a supporter countering said face of the templating body and having a smooth front face,
forming many minute recess on one side of said film by templating a face of the film between the templating body and the supporter under 50° C. or more and 120° C. or less.

23. A method for producing the heat sensitive stencil plate material comprising,
inserting a extended low melting point film by copolymerizing polyethylene terephthalate(PET) with 20% or less of crystallinity and polybutylene terephthalate(PBT), between a templating body having many minute projections on its face and a supporter countering said face of the templating body and having a smooth face,
forming many minute recess on one side of said film by templating a face of the film between the templating body and the supporter under 40° C. or more and 100° C. or less.

24. A method for producing a heat sensitive stencil plate material according to anyone of claims 18-23,
wherein said templating is carried out under a pressure of 100 million Pa or more (1 or more t/cm²) when a working temperature of the film is below a glass transition point of this film.

25. A method for producing a heat sensitive stencil plate material according to anyone of claims 18-23 wherein said die pressing processing is performed under a pressure of 20 million Pa or more (2 or more kg/cm²) when a processing temperature of the film is or more glass transition point of this film.

26. A method for producing a heat sensitive stencil plate material according to anyone of claims 18-23,
wherein said templating is performed under P Pa of a working pressure force of 10⁴×10^{2(m-t)/(m-g)} or more when a working temperature is t° C., a melting point of the film is m° C. and a glass transition point of the film is g° C.

27. A method for producing the heat sensitive stencil plate material according to anyone of claims 18-23,
wherein said templating body and said supporter are a first and a second cylindrical bodies of revolution, respectively.

28. A method for producing a heat sensitive stencil plate material according to anyone of claims 18-23,
wherein said templating body is an endless band-like body of revolution, and said supporter is a cylindrical body of revolution countering a face of the endless band-like body of revolution, and makes a press force act on a face of the plate material.

29. A method for producing a heat sensitive stencil plate material according to anyone of claims 18-23,
including an extension processing further after carrying out templating of said minute recess.

30. A method for producing a heat sensitive stencil plate material according to anyone of claims 18-23,
wherein said minute recess is a penetrated hole which is so small not to permit ink permeability,
an opening diameter of one side of the film is larger than an opening diameter of other side of the film.

31. A method for producing a heat sensitive stencil plate material according to anyone of claims 18-23,
wherein said minute recess is a dent which reduces the thickness of said film partially and forms a thin bottom.

32. An apparatus for producing a sensitive stencil plate material for stencil printing comprising,
a film conveyance path for conveying the heat sensitive plate material for stencil printing which consists of a polyester film with a predetermined thickness,
a templating body provided with a face having many minute projections and facing said film conveyance path,
a supporter countering said face of the templating body and having a smooth face facing said film conveyance path so that the film conveyance path is placed between the templating body and the supporter,
when a working temperature is t° C., a melting point of the film is m° C. and a glass transition point of the film is g° C., said templating body and said supporter make a P—Pa pressure force of 10⁴×10^{2(m-t)/(m-g)} more than act to the face of the stencil plate material conveying between the templating body and the supporter, and form many minute recesses on one side of the stencil plate material.

33. An apparatus for producing a sensitive stencil plate material for stencil printing according to claim 32,
wherein said polyester film is an extended polyethylene-terephthalate (PET) film.

34. An apparatus for producing a sensitive stencil plate material for stencil printing according to claim 32,
wherein said polyester film is an extended polyethylene-terephthalate (PET) film with 20% or less of crystallinity.

35. An apparatus for producing a sensitive stencil plate material for stencil printing according to claim 32,
wherein said polyester film a extended low melting point film by copolymerizing polyethylene terephthalate(PET) and polybutylene terephthalate(PBT).

36. An apparatus for producing a sensitive stencil plate material for stencil printing according to claim 32,
wherein said polyester film a low melting point film by copolymerizing polyethylene terephthalate(PET) with 20% or less of crystallinity and polybutylene terephthalate(PBT).

37. An apparatus for producing a sensitive stencil plate material for stencil printing according to anyone of claims 32-36,
wherein said templating body and said supporter are a first and a second cylindrical bodies of revolution, respectively.

38. An apparatus for producing a sensitive stencil plate material for stencil printing according to anyone of claims 32-36,
wherein said templating body is an endless band-like body of revolution, and said supporter is a cylindrical body of revolution countering a face of the endless band-like body of revolution, and makes a press force act on a face of the plate material.

39. An apparatus for producing a sensitive stencil plate material for stencil printing according to anyone of claims 32-36,
wherein an extension processing is further performed after templating said minute recess.

40. An apparatus for producing a sensitive stencil plate material for stencil printing according to anyone of claims 32-36,
wherein said minute recess is a penetrated hole which is so small not to permit ink permeability.

41. An apparatus for producing a sensitive stencil plate material for stencil printing according to anyone of claims 32-36,
wherein said minute recess is a dent which reduces a thickness of said film partially and forms a thin bottom.

42. A stencil plate printing machine is provided with the apparatus according to anyone of claims 32-36.
